(19) United States
(12) Patent Application Publication
(10) Pub. No.: US 2020/0366967 A1
(43) Pub. Date: Nov. 19, 2020

(54) METHOD AND SYSTEM FOR MONITORING QUALITY OF STREAMING MEDIA

(71) Applicant: Wangsu Science & Technology Co., Ltd., Shanghai (CN)

(72) Inventors: Yanhong LIU, Shanghai (CN); Rongqiang WEI, Shanghai (CN)

(21) Appl. No.: 16/984,156

(22) Filed: Aug. 4, 2020

Related U.S. Application Data
(63) Continuation of application No. PCT/CN2019/090343, filed on Jun. 6, 2019.

(30) Foreign Application Priority Data
May 7, 2019 (CN) 201910374863.8

(51) Int. Cl. H04N 21/647; H04N 21/24; H04N 21/643

(52) U.S. Cl. CPC H04N 21/64738; H04N 21/64769; H04N 21/64322; H04N 21/2402

(57) ABSTRACT

The present disclosure discloses a method and a system for monitoring quality of streaming media. The method includes: simulating, by a terminal player, playing a streaming media resource in a fixed period; recording, by the terminal player, indicator data for simulating playing the streaming media resource; sending, by the terminal player, the indicator data to a monitoring server; receiving, by the monitoring server, the indicator data; and determining, by the monitoring server, current quality of streaming media based on the indicator data. The present disclosure can detect a quality problem of streaming media services in time.

### CROSS-REFERENCE TO RELATED APPLICATIONS

The present disclosure is a continuation of PCT Application No. PCT/CN2019/090343, entitled “METHOD AND SYSTEM FOR MONITORING QUALITY OF STREAMING MEDIA”, which claims priority to Chinese Patent Application No. 201910374863.8, filed on May 7, 2019 and entitled “METHOD AND SYSTEM FOR MONITORING QUALITY OF STREAMING MEDIA”, each of which is incorporated herein by reference in its entirety.

### TECHNICAL FIELD

The present disclosure relates to streaming media technologies, and in particular, to a method and a system for monitoring quality of streaming media.

### BACKGROUND

Streaming media refers to a technology and a process in which a series of media data is compressed and segmented, and the segmented data is sent via a network. Thus a video and audio are instantly transmitted via the network for viewing. Streaming media services, for example, live broadcasting service and video-on-demand service, are becoming more and more popular, and quality of the streaming media services can significantly affect experience of a terminal user.

Generally, operation and maintenance personnel may find that there is a quality problem in the streaming media services only after the terminal user feeds back the problem.

### SUMMARY

To resolve a problem in existing technologies, embodiments of the present disclosure provide a method and a system for monitoring quality of streaming media. The technical solutions are as follows.

A first aspect provides a method for monitoring quality of streaming media. The method includes:

simulating, by a terminal player, playing a streaming media resource in a fixed period;

recording, by the terminal player, indicator data for simulating playing the streaming media resource;

sending, by the terminal player, the indicator data to a monitoring server; and

determining, by the monitoring server, current quality of streaming media based on the indicator data.

Optionally, the step of simulating, by a terminal player, playing a streaming media resource in a fixed period includes:

sending, by the monitoring server, task information to the terminal player, where the task information includes a network address, a play duration, a buffer size, and a play period of the streaming media resource; and simulating, by the terminal player, playing the streaming media resource in the fixed period after receiving the task information.

Optionally, the step of simulating, by the terminal player, playing a streaming media resource in a fixed period includes:

sending, by the terminal player according to the play period, request information of obtaining the streaming media resource, where the request information includes the network address of the streaming media resource;

buffering, by the terminal player after receiving the streaming media resource, the streaming media resource based on the buffer size in the task information, and playing the streaming media resource; and ending playing when a duration in which the terminal player plays the streaming media resource reaches the play duration in the task information.

Optionally, before the step of sending, by the monitoring server, task information to the terminal player, the method includes:

configuring, by the monitoring server, monitoring information, where the monitoring information includes the task information, an operating system of a terminal player, and a region of the terminal player;

receiving, by the monitoring server, an operating system of the terminal player and a region of the terminal player that are sent by the terminal player which plays the streaming media resource; and

associating the terminal player which plays the streaming media resource with the task information if the terminal player which plays the streaming media resource has the same operating system and the same region with that of the terminal player in the monitoring information.

Optionally, after the step of associating, by the monitoring server, the terminal player which plays the streaming media resource with the task information, the method includes:

sending, by the terminal player, task request information to the monitoring server; and

sending, by the monitoring server, the task information associated with the terminal player to the terminal player after receiving the task request information.

Optionally, the terminal player further sends an Internet Protocol (IP) address of a streaming media server and an IP address of a domain name system (DNS) server while sending the indicator data to the monitoring server.

Optionally, the step of determining, by the monitoring server, the current quality of streaming media based on the indicator data includes:

computing, by the monitoring server, a first reference value based on the indicator data, where the first reference value is equal to a ratio of a quantity of playing the streaming media resource by the terminal player successfully in a preset period and a total quantity of playing the streaming media resource by the terminal player in the preset period; and determining that the current quality of streaming media does not meet a requirement if the first reference value is less than a first preset value.

Optionally, the step of determining, by the monitoring server, the current quality of streaming media based on the indicator data further includes:

computing a second reference value based on the indicator data if the first reference value is greater than or equal to the first preset value, where the second reference value is equal to a ratio of a quantity of playing the streaming media resource by the terminal player normally in the preset period and the total quantity of playing the streaming media resource by the terminal player in the preset period; and

determining that the current quality of streaming media meets the requirement if the second reference value is greater than a second preset value; otherwise, determining that the current quality of streaming media does not meet the requirement.

Optionally, after the step of determining, by the monitoring server, that the current quality of streaming media does not meet the requirement, the method includes:

generating, by the monitoring server, alarm information, and sending the alarm information via email, short message service, or WeChat.

Optionally, after the step of receiving, by the monitoring server, the indicator data, the method further includes:

drawing a time distribution diagram of the key indicator data in a sequence of generating key indicator data, where the key indicator data includes one or more of the following: a DNS resolution time, a connection time, an initial packet time, an initial buffer time, an initial continuous play time, a buffer time after each stucking, and a continuous play time after each stucking.

Optionally, after the step of receiving, by the monitoring server, the indicator data, the method further includes:

drawing a curve graph of a preparation time before an initial buffer based on the indicator data; or

drawing a curve graph of a sum of a preparation time before an initial buffer and a total buffer time based on the indicator data.

A second aspect provides a system for monitoring quality of streaming media. The system includes a terminal player and a monitoring server;

the terminal player is configured to: simulate playing a streaming media resource in a fixed period, record indicator data for simulating playing the streaming media resource, and send the indicator data to the monitoring server; and

the monitoring server is configured to: receive the indicator data, and determine current quality of streaming media based on the indicator data.

Optionally, the monitoring server is configured to send task information to the terminal player, where the task information includes a network address, a play duration, a buffer size, and a play period of the streaming media resource; and

the terminal player is configured to simulate playing the streaming media resource in the fixed period after receiving the task information.

Optionally, the terminal player is configured to:

send, according to the play period, request information of obtaining the streaming media resource, where the request information includes the network address of the streaming media resource;

buffer, after receiving the streaming media resource, the streaming media resource based on the buffer size in the task information, and play the streaming media resource; and

end playing when a duration in which the terminal player plays the streaming media resource reaches the play duration in the task information.

Optionally, the monitoring server is configured to:

configure monitoring information, where the monitoring information includes the task information, an operating system of the terminal player, and a region of the terminal player;

receive an operating system of the terminal player and a region of the terminal player that are sent by the terminal player which plays the streaming media resource; and

associate the terminal player which plays the streaming media resource with the task information if the terminal player which plays the streaming media resource has the same operating system and the same region with that of the terminal player in the monitoring information.

Optionally, the terminal player is configured to send task request information to the monitoring server; and

the monitoring server is configured to send task information associated with the terminal player to the terminal player after receiving the task request information.

Optionally, the terminal player further sends an IP address of a streaming media server and an IP address of a DNS server while sending the indicator data to the monitoring server.

Optionally, the monitoring server is configured to:

compute a first reference value based on the indicator data, where the first reference value is equal to a ratio of a quantity of playing the streaming media resource by the terminal player successfully in a preset period and a total quantity of playing the streaming media resource by the terminal player in the preset period; and

determine that the current quality of streaming media does not meet a requirement if the first reference value is less than a first preset value.

Optionally, the monitoring server is configured to:

compute a second reference value based on the indicator data if the first reference value is greater than or equal to the first preset value, where the second reference value is equal to a ratio of a quantity of playing the streaming media resource by the terminal player normally in the preset period and the total quantity of playing the streaming media resource by the terminal player in the preset period; and

determine that the current quality of streaming media meets the requirement if the second reference value is greater than a second preset value; otherwise, determine that the current quality of streaming media does not meet the requirement.

Optionally, the monitoring server is further configured to generate alarm information after determining that the current quality of streaming media does not meet the requirement, and send the alarm information via email, short message service, or WeChat.

Optionally, the monitoring server is configured to:

draw a time distribution diagram of the key indicator data in a sequence of generating key indicator data, where the key indicator data includes one or more of the following: a DNS resolution time, a connection time, an initial packet time, an initial buffer time, an initial continuous play time, a buffer time after each stucking, and a continuous play time after each stucking.

Optionally, the monitoring server is configured to:

draw a curve graph of a preparation time before an initial buffer based on the indicator data; or

draw a curve graph of a sum of a preparation time before an initial buffer and a total buffer time based on the indicator data.

A third aspect provides a terminal. The terminal includes:

at least one processor; and

a memory connected and communicated with the at least one processor, configured to store instructions executable by the at least one processor, where

the instructions are executed by the at least one processor to cause the at least one processor to perform a processing process performed by the terminal player in the method for monitoring quality of streaming media according to the first aspect.

A fourth aspect provides a computer readable storage medium that stores computer programs, where when executed by a processor, the computer programs implement the processing process performed by the terminal player in the method for monitoring quality of streaming media according to the first aspect.

The terminal player in the embodiments of the present disclosure may simulate a process that a client plays a streaming media resource, and a quality problem of streaming media services may be found in advance before a customer discovers anomalies such as a stucking and is fed back to a video source provider and a content delivery network (CDN) server in time, to be resolved timely. In addition, the terminal player may record various pieces of indicator data in the process of playing the streaming media resource, and report to the monitoring server, and the monitoring server can uniformly deal with the indicator data reported by each terminal player and analyze reasons for poor quality of streaming media, thus the efficiency of operation and maintenance could be improved.

### BRIEF DESCRIPTION OF THE DRAWINGS

To describe technical solutions of embodiments of the present disclosure more clearly, accompanying drawings required for describing the embodiments are described below briefly. Apparently, the accompanying drawings in the following descriptions merely show some embodiments of the present disclosure, and a person of ordinary skill in the art can obtain other drawings according to the accompanying drawings without creative efforts.

FIG. 1 is a schematic diagram of a network framework according to an embodiment of the present disclosure;

FIG. 2 is a flowchart of a method for monitoring quality of streaming media according to an embodiment of the present disclosure; and

FIG. 3 is a structural block diagram of a terminal according to an embodiment of the present disclosure.

### DETAILED DESCRIPTION

A conventional method for monitoring quality of streaming media has the following disadvantages.

There is an obvious time delay in a manner in which a quality problem of streaming media services is fed back by a terminal user, and normal services cannot be resumed in time because the problem is not detected in time, affecting user experience. In addition, after the problem of streaming media service quality is detected, operation and maintenance personnel generally need to search a terminal log and locate the problem. However, the terminal log is complex and diverse, and is not conducive to unified processing. Consequently, it is difficult to investigate the problem.

To make objectives, technical solutions, and advantages of the present disclosure clearer, the following further describes embodiments of the present disclosure in detail with reference to accompanying drawings.

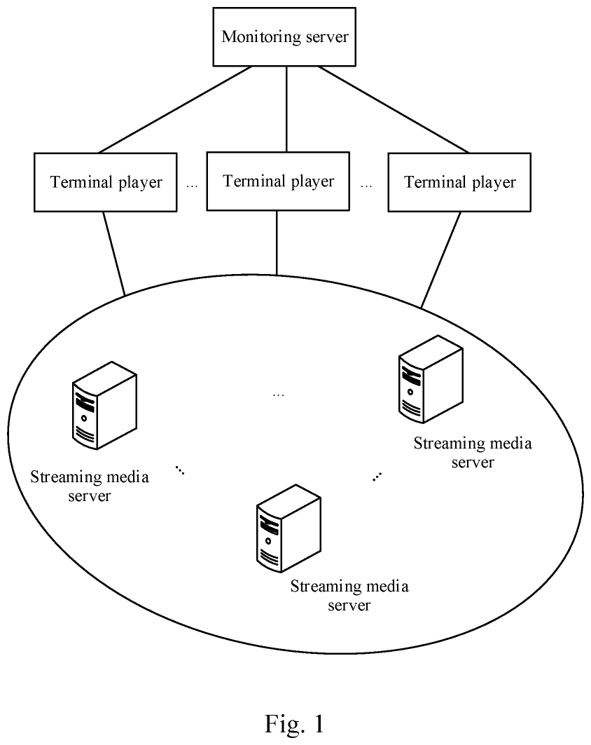

An embodiment of the present disclosure provides a method for monitoring quality of streaming media. The method may be applied to a network framework shown in FIG. 1. The network framework includes a terminal player, a streaming media server, and a monitoring server. The streaming media server may be a CDN server and is configured to store a streaming media resource. The terminal player simulates, in a fixed period, a client playing the streaming media resource, that is, obtains the streaming media resource from the streaming media and plays the streaming media resource, and records indicator data for simulating playing the streaming media resource, for example, a status code, a DNS resolution time, a connection time, an initial packet time, an initial buffer time, an initial continuous play time, a buffer time after each stucking, and a continuous play time after each stucking. The terminal player sends the indicator data to the monitoring server, and the monitoring server receives the indicator data, and determines current quality of streaming media based on the indicator data.

The terminal player and the monitoring server may each include a processor, a memory, and a transceiver. The processor may be configured to perform the following process of monitoring quality of streaming media. The memory may be configured to store data needed and generated in the following processing process. The transceiver may be configured to receive and send relevant data in the following processing process.

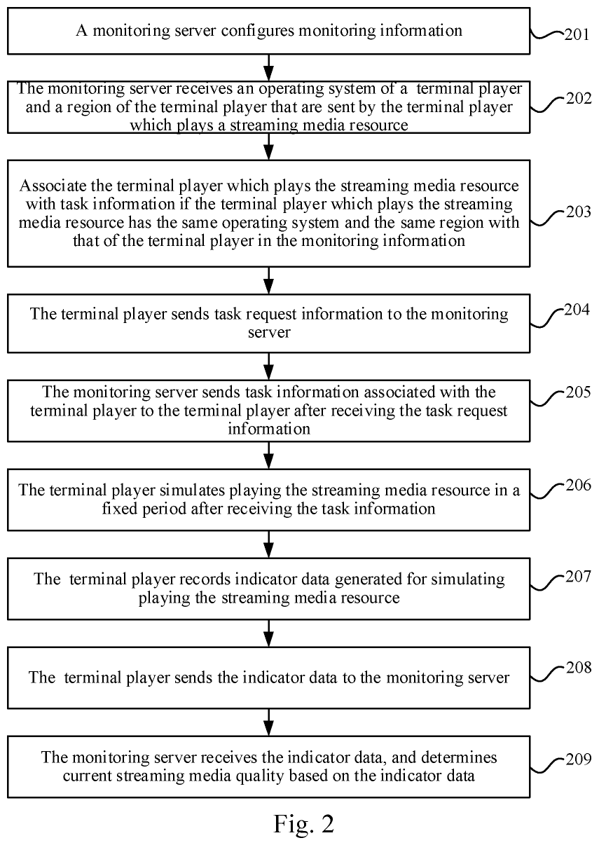

The following describes a processing process shown in FIG. 2 in detail with reference to specific embodiments, and content may be as follows.

At step 201, a monitoring server configures monitoring information. Herein, the monitoring information includes task information, an operating system of a terminal player, and a region of the terminal player.

In this embodiment of the present disclosure, the monitoring server is configured to centrally manage terminal players in each region. The monitoring server may preconfigure the monitoring information, and each piece of monitoring information includes task information, an operating system of a terminal player, and a region of the terminal player. The task information includes a network address, a play duration, a buffer size, and a play period of a streaming media resource to be played. The network address of the streaming media resource is represented by a uniform resource locator (URL).

At step 202, the monitoring server receives an operating system of a terminal player and a region of the terminal player that are sent by the terminal player which plays the streaming media resource.

During implementation, the terminal player which plays the streaming media resource reports a heartbeat to the monitoring server through a Hypertext Transfer Protocol (HTTP) interface, and reports terminal information such as an IP address, an operating system of the terminal player and a region of the terminal player; and the monitoring server stores the collected terminal information into a database.

At step 203, the terminal player is associated with the task information if the operating system of the terminal player which plays the streaming media resource is the same as an operating system of a terminal player in the monitoring information, and the region of the terminal player which plays the streaming media resource is the same as the terminal player in the monitoring information.

During implementation, there may be a plurality of terminal players that sends the terminal information to the monitoring server, and the monitoring server searches, based on the preconfigured monitoring information, the terminal information matching the task information, thereby matching a suitable terminal player which plays the streaming media resource with the task information, that is, the terminal player has the same operating system and the same region with that of the terminal player in the monitoring information.

The monitoring server may preload the task information matching the terminal player into a memory in a j son format.

At step 204, the terminal player sends task request information to the monitoring server.

During implementation, the terminal player may periodically send the task request information to the monitoring server through the HTTP interface.

At step 205, the monitoring server sends task information associated with the terminal player to the terminal player after receiving the task request information.

Optionally, the monitoring server may also periodically send corresponding task information to the terminal player.

At step 206, the terminal player simulates playing a streaming media resource in the fixed period after receiving the task information.

The task information includes a network address, a play duration, a buffer size, and a play period of the streaming media resource to be played. A process in which the terminal player executes, based on an instruction in the task information, a task of simulating playing the streaming media resource is as follows. The terminal player sends, according to the play period, request information of obtaining the streaming media resource, where the request information includes a URL of the streaming media resource, that is, a network address. A DNS server receives the request information, and performs domain name resolution on a domain name in the URL to obtain an IP address of the streaming media server corresponding to the domain name. The DNS server sends the IP address obtained through resolution to the terminal player. The terminal player sends, to the streaming media server with the IP address after receiving the IP address, the request information of obtaining the streaming media resource, and if there is a streaming media resource to be played cached in the streaming media server, the streaming media resource is sent to the terminal player. The terminal player receives the streaming media resource, buffers the streaming media resource based on the buffer size in the task information, and plays the streaming media resource. Playing is ended when a duration in which the terminal player plays the streaming media resource reaches the play duration in the task information.

In a process of playing the streaming media resource, the terminal player decodes the data packet and parses an audio-video time stamp after obtaining a streaming media data packet, and when the time stamp reaches a specified play duration in the task information, ends the play task.

It should be noted that, a process in which the terminal player executes a task of simulating playing the streaming media resource is the same as or similar to a process in which a general client performs playing the streaming media resource, and other specific processing processes are not described herein.

During implementation, the terminal player parses the task information after receiving the task information, generates a task configuration file, and stores the task configuration file in a specified directory. When a moment of playing the streaming media resource is reached, the task configuration file is accessed, and the task of simulating playing the streaming media resource is executed based on an instruction in the task configuration file.

At step 207, the terminal player records the indicator data for simulating playing the streaming media resource.

The indicator data refers to data that may reflect or be used to compute quality of streaming media service. In above mentioned process, when the terminal player executes the task of simulating playing the streaming media resource, and a processing rate of each step affects fluency of an entire process of playing the streaming media resource, so that the indicator data in the processing of each step needs to be recorded. After determining that there is a problem in current quality of streaming media based on the indicator data, the monitoring server may further determine, based on the indicator data, specific reasons for poor quality of streaming media.

The indicator data in the process of simulating playing the streaming media resource includes one or more of the following: a status code, a DNS resolution time, a connection time, an initial packet time, an initial buffer time, an initial continuous play time, a buffer time after each stucking, and a continuous play time after each stucking.

The status code refers to a result of playing the streaming media resource, for example, playing successfully or failing to play. The DNS resolution time refers to a period from a moment of starting to execute the task of simulating playing the streaming media resource, to a moment of receiving a result of a domain name resolution. The connection time refers to a period from a moment of ending the DNS resolution to a moment of establishing a connection between the terminal player and the streaming media server successfully. The initial packet time refers to a period from a moment of ending the connection between the terminal player and the streaming media server to a moment of receiving a first data packet. The initial buffer time refers to a period from a moment of ending the initial packet to a moment of starting playing the streaming media resource.

Optionally, the indicator data may further include one or more of the following: a file size, a total download time, a first download file size, a request time, a response time, a total time of executing the task, an average download rate, buffer times, a secure sockets layer (SSL) handshaking time, a play duration, and a buffer size of the streaming media. The request time refers to a period from the start moment of executing the task of simulating playing the streaming media resource to a moment of sending the request information. The response time refers to a period from a moment of sending the request information to a moment of receiving a response signal of the streaming media server.

At step 208, the terminal player sends the indicator data to the monitoring server.

At step 209, the monitoring server receives the indicator data, and determines current quality of streaming media based on the indicator data.

The monitoring server may determine the current quality of streaming media in the fixed period. A length of each fixed period is longer than a length of a period that the terminal player executes a task of playing the streaming media resource. A specific process in which the monitoring server determines the current quality of streaming media based on the indicator data includes: computing, by the monitoring server, a first reference value based on the indicator data, where the first reference value is equal to a ratio of a quantity of playing the streaming media resource by the terminal player successfully in a preset period and a total quantity of playing the streaming media resource by the terminal player in the preset period; and determining that the current quality of streaming media does not meet a requirement if the first reference value is less than a first preset value; or computing a second reference value based on the indicator data if the first reference value is greater than or equal to the first preset value, where the second reference value is equal to a ratio of a quantity of playing the streaming media resource by the terminal player normally in the preset period and the total quantity of playing the streaming media resource by the terminal player in the preset period, and the playing the streaming media resource by the terminal player normally refers to a case in which a preparation time before an initial buffer is less than a first preset time during playing the streaming media resource, or a case in which a sum of the preparation time before the initial buffer and a total buffer time is less than a second preset time during playing the streaming media resource; and determining that the current quality of streaming media meets the requirement if the second reference value is greater than a second preset value; otherwise determining that the current quality of streaming media does not meet the requirement.

The terminal player periodically executes the task of playing the streaming media resource, so that in the preset period, the monitoring server may receive indicator data that is reported by the terminal player in a plurality of play periods, and determine a streaming media play status in each play period based on the reported indicator data. In the process of determining the current quality of streaming media, whether the streaming media is played successfully may be determined through the status code. That the streaming media is successfully played means that the streaming media resource to be played is played for the play duration specified by the task information. The preparation time before the initial buffer is equal to a sum of the DNS resolution time, the connection time, and the initial packet time.

The monitoring server generates alarm information when determining that the current quality of streaming media does not meet a preset requirement, that is, service quality is poor, and sends the alarm information via email, short message service, or WeChat to push the alarm information to relevant personnel, so that the relevant personnel can learn the quality problem of streaming media services in time, and perform optimization processing timely.

After receiving the indicator data, the monitoring server may further draw a time distribution diagram of the key indicator data in a sequence of generating key indicator data. The time distribution diagram is used to show a time occupied by the processing process of each step in a process of executing the task of playing the streaming media resource. The key indicator data includes one or more of the following: a DNS resolution time, a connection time, an initial packet time, an initial buffer time, an initial continuous play time, a buffer time after each stucking, and a continuous play time after each stucking.

Optionally, the terminal player may draw a curve graph of the preparation time before the initial buffer based on the indicator data; or draw a curve graph of the sum of the preparation time before the initial buffer and the total buffer time based on the indicator data. The curve graph uses a time as a horizontal coordinate, and uses the preparation time before the initial buffer for each task of simulating playing the streaming media resource, or the sum of the preparation time before the initial buffer and the total buffer time for each task of simulating playing the streaming media resource as a vertical coordinate, so that the relevant personnel can conveniently pay attention to the changes of the quality of streaming media in real time.

The indicator data reported by the terminal player to the monitoring server may further include one or more of the following: a file size, a total download time, a first download file size, a request time, a response time, a total time of executing the task, an average download rate, buffer times, an SSL handshaking time, a play duration, and a buffer size of the streaming media. The indicator data may be used as reference information for analyzing quality of streaming media.

It should be noted that, for the indicator data reported by the terminal player, the indicator data used to analyze the quality of streaming media, the indicator data shown by the time distribution diagram, and the indicator data shown by the curve graph, corresponding indicator data may be selected as needed, and there is no specific limitation on selecting various pieces of indicator data herein.

During implementation, after analyzing and obtaining the quality of streaming media service, the monitoring server may store an analysis result and an analysis basis, that is, the indicator data, into a database to facilitate future query.

The terminal player further sends an IP address of the streaming media server and an IP address of the DNS server while sending the indicator data to the monitoring server. The streaming media server refers to a server that provides the streaming media resource to the terminal player. The DNS server refers to a server that provides a domain name resolution service to the terminal player. When the streaming media server or the DNS server has a problem based on analysis of the indicator data, fault analysis and fault investigation may be targetedly carried out, thus the efficiency of operation and maintenance could be improved.

To analyze quality of streaming media services serving different operating systems, each piece of task information may match a plurality of terminal players with different operating systems, and the operating system of the terminal player may be a Linux system, a windows system, or an android system. It should be noted that, the terminal player in the embodiment of the present disclosure supports a headless mode to simulate playing the streaming media resource, that is, simulate a process of playing the streaming media resource on a headless machine, so that a server may perform batch distributed detection, without being limited to terminals such as a computer with a screen and a mobile phone.

The terminal player in this embodiment of the present disclosure may detect, by simulating a process that a client plays a streaming media resource, and the problem of streaming media service quality may be found in advance before a customer discovers anomalies such as a stucking, and is fed back to a video source provider and a CDN server in time, to be resolved timely. In addition, the terminal player may record various pieces of indicator data in the process of playing the streaming media resource, and report to the monitoring server, and the monitoring server can uniformly deal with the indicator data reported by each terminal player and analyze reasons for poor quality of streaming media, thus the efficiency of operation and maintenance could be improved.

Based on the same inventive concept as the foregoing method for monitoring quality of streaming media, an embodiment of the present disclosure further provides a system for monitoring quality of streaming media. The system includes a terminal player and a monitoring server.

The terminal player is configured to: simulate playing a streaming media resource in a fixed period, record indicator data for simulating playing the streaming media resource, and send the indicator data to the monitoring server.

The monitoring server is configured to: receive the indicator data, and determine current quality of streaming media based on the indicator data.

For example, the monitoring server is configured to send task information to the terminal player, where the task information includes a network address, a play duration, a buffer size, and a play period of the streaming media resource; and

the terminal player is configured to simulate playing the streaming media resource based on the fixed period after receiving the task information.

For example, the terminal player is configured to:

send, according to the play period, request information of obtaining the streaming media resource, where the request information includes the network address of the streaming media resource;

buffer, after receiving the streaming media resource, the streaming media resource based on the buffer size in the task information, and play the streaming media resource; and

end playing when a duration in which the terminal player plays the streaming media resource reaches the play duration in the task information.

For example, the monitoring server is configured to:

configure monitoring information, where the monitoring information includes the task information, an operating system of a terminal player, and a region of the terminal player;

receive an operating system of the terminal player and a region of the terminal player that are sent by the terminal player which plays the streaming media resource; and

associate the terminal player which plays the streaming media resource with the task information if the terminal player which plays the streaming media resource has the same operating system and the same region with that of the terminal player in the monitoring information.

For example, the terminal player is configured to send task request information to the monitoring server; and

the monitoring server is configured to send task information associated with the terminal player to the terminal player after receiving the task request information.

For example, the terminal player further sends an IP address of a streaming media server and an IP address of a DNS server while sending the indicator data to the monitoring server.

For example, the monitoring server is configured to:

compute a first reference value based on the indicator data, where the first reference value is equal to a ratio of a quantity of playing the streaming media resource by the terminal player successfully in a preset period and a total quantity of playing the streaming media resource by the terminal player in the preset period; and determine that the current quality of streaming media does not meet a requirement if the first reference value is less than a first preset value.

For example, the monitoring server is configured to:

compute a second reference value based on the indicator data if the first reference value is greater than or equal to the first preset value, where the second reference value is equal to a ratio of a quantity of normal plays in the preset period and the total quantity of plays in the preset period; and

determine that the current quality of streaming media meets the requirement if the second reference value is greater than a second preset value; otherwise, determine that the current quality of streaming media does not meet the requirement.

For example, the monitoring server is further configured to generate alarm information after determining that the current quality of streaming media does not meet the requirement, and send the alarm information via email, short message service, or WeChat.

For example, the monitoring server is configured to:

draw a time distribution diagram of the key indicator data in a sequence of generating key indicator data, where the key indicator data includes one or more of the following: a DNS resolution time, a connection time, an initial packet time, an initial buffer time, an initial continuous play time, a buffer time after each stucking, and a continuous play time after each stucking.

For example, the monitoring server is configured to:

draw a curve graph of a preparation time before an initial buffer based on the indicator data; or

draw a curve graph of a sum of the preparation time before the initial buffer and a total buffer time based on the indicator data.

The terminal player in this embodiment of the present disclosure may detect, by simulating a process that a client plays a streaming media resource, a quality problem of streaming media services may be found in advance before a customer discovers anomalies such as a stucking, and is fed back to a video source provider and a CDN server in time, to be resolved timely. In addition, the terminal player may record various pieces of indicator data in the process of playing the streaming media resource, and report to the monitoring server, and the monitoring server can uniformly deal with the indicator data reported by each terminal player and analyze reasons for poor quality of streaming media, thus the efficiency of operation and maintenance could be improved.

It should be noted that, the system for monitoring quality of streaming media provided in the foregoing embodiment and the embodiment of the method for monitoring quality of streaming media have the same concept. For a specific implementation process of the system, refer to the method embodiment, and details are not described herein again.

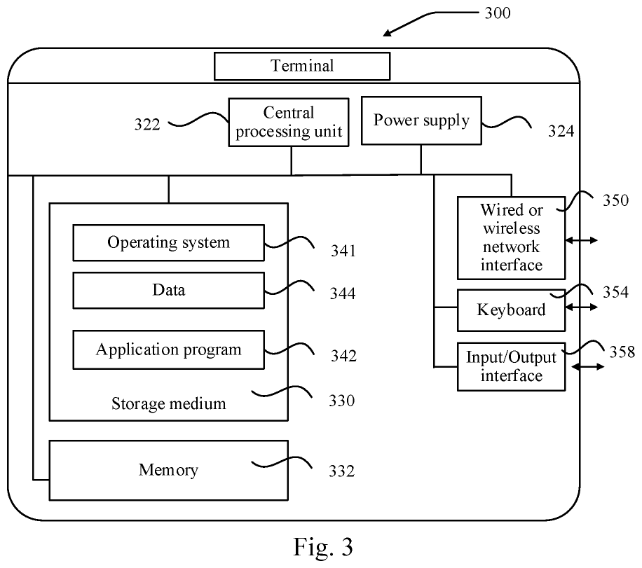

FIG. 3 is a structural block diagram of a terminal according to an embodiment of the present disclosure. The terminal 300 may vary greatly because of different configurations or performance and may include one or more central processing units 322 (for example, one or more processors) and memories 332, and one or more storage medium 330 (for example, one or more massive storage devices) that store application programs 342 or data 344. The memory 332 and the storage medium 330 may be temporary storages or persistent storages. Programs stored in the storage medium 330 may include one or more modules (not shown in the figures), and each module may include a series of instruction operations on a node device. Further, the central processing unit 322 may be configured to: communicate with the storage medium 330 and perform, in the terminal 300, a series of instruction operations stored in the storage medium 330.

The terminal 300 may further include one or more power supplies 324, one or more wired or wireless network interfaces 350, one or more input/output interfaces 358, one or more keyboards 354, and/or, one or more operating systems 341, for example, Windows Server™, Mac OS X™, Unix™, Linux™, and FreeBSD™.

The terminal 300 may include a memory, and one or more computer programs, where the one or more computer programs are stored in the memory, and the terminal 300 is configured such that the one or more computer programs are executed by one or more processors to implement the processing process performed by the terminal player in the foregoing method for monitoring quality of streaming media:

simulating playing a streaming media resource in a fixed period;

recording indicator data for simulating playing the streaming media resource; and

sending the indicator data to a monitoring server.

A person of ordinary skill in the art may understand that all or some of the steps of the foregoing embodiments may be implemented through hardware, or may be implemented by relevant hardware instructed by a program. The program may be stored in a computer readable storage medium. The storage medium may be a read-only memory, a magnetic disk, or an optical disk.

The foregoing descriptions are merely exemplary embodiments of the present disclosure, but are not intended to limit the present disclosure. Any modifications, equivalent substitutions, and improvements made within the spirit and principle of the present disclosure shall fall within the protection scope of the present disclosure.

What is claimed is:

1. A method for monitoring quality of streaming media, wherein the method comprises:
simulating, by a terminal player, playing a streaming media resource in a fixed period;
recording, by the terminal player, indicator data for simulating playing the streaming media resource;
sending, by the terminal player, the indicator data to a monitoring server; and
determining, by the monitoring server, current quality of streaming media based on the indicator data.

2. The method according to claim 1, wherein the step of simulating, by a terminal player, playing a streaming media resource in a fixed period comprises:
sending, by the monitoring server, task information to the terminal player, wherein the task information comprises a network address, a play duration, a buffer size, and a play period of the streaming media resource; and
simulating, by the terminal player, playing the streaming media resource in the fixed period after receiving the task information.

3. The method according to claim 2, wherein the step of simulating, by a terminal player, playing a streaming media resource in a fixed period comprises:
sending, by the terminal player according to the play period, request information of obtaining the streaming media resource, wherein the request information comprises the network address of the streaming media resource;
buffering, by the terminal player after receiving the streaming media resource, the streaming media resource based on the buffer size indicated by the task information, and playing the streaming media resource; and
ending playing when a duration in which the terminal player plays the streaming media resource reaches the play duration indicated by the task information.

4. The method according to claim 2, wherein before the step of sending, by the monitoring server, task information to the terminal player, the method comprises:
configuring, by the monitoring server, monitoring information, wherein the monitoring information comprises the task information, an operating system of a terminal player, and a region of the terminal player;
receiving, by the monitoring server, an operating system of the terminal player and a region of the terminal player sent by the terminal player which plays the streaming media resource; and
if the terminal player which plays the streaming media resource has the same operating system and the same region with that of the terminal player in the monitoring information, associate the terminal player which plays the streaming media resource with the task information.

5. The method according to claim 4, wherein after the step of associating the terminal player which plays the streaming media resource with the task information, the method comprises:
sending, by the terminal player, task request information to the monitoring server; and
sending, by the monitoring server, task information associated with the terminal player to the terminal player after receiving the task request information.

6. The method according to claim 4, wherein after the step of if the terminal player which plays the streaming media resource has the same operating system and the same region with that of the terminal player in the monitoring information, associate the terminal player which plays the streaming media resource with the task information, the method comprises: preloading, by the monitoring server, the task information matching the terminal player into a memory in a j son format.

7. The method according to claim 1, wherein the terminal player further sends an Internet Protocol (IP) address of a streaming media server and an IP address of a domain name system (DNS) server while sending the indicator data to the monitoring server.

8. The method according to claim 1, wherein the step of determining, by the monitoring server, current quality of streaming media based on the indicator data comprises:
computing, by the monitoring server, a first reference value based on the indicator data, wherein the first reference value is equal to a ratio of a quantity of playing the streaming media resource by the terminal player successfully in a preset period and a total quantity of playing the streaming media resource by the terminal player in the preset period; and
determining that the current quality of streaming media does not meet a requirement if the first reference value is less than a first preset value.

9. The method according to claim 8, wherein the step of determining, by the monitoring server, current quality of streaming media based on the indicator data further comprises:
computing a second reference value based on the indicator data if the first reference value is greater than or equal to the first preset value, wherein the second reference value is equal to a ratio of a quantity of playing the streaming media resource by the terminal player normally s in the preset period and the total quantity of playing the streaming media resource by the terminal player in the preset period; and
determining that the current quality of streaming media meets requirement if the second reference value is greater than a second preset value; otherwise, determining that the current quality of streaming media does not meet the requirement.

10. The method according to claim 9, wherein after the step of determining, by the monitoring server, that the current quality of streaming media does not meet the requirement, the method comprises:
generating, by the monitoring server, alarm information, and sending the alarm information via email, short message service, or WeChat.

11. The method according to claim 1, wherein after the receiving, by the monitoring server, the indicator data, the method further comprises:
drawing a time distribution diagram of the key indicator data in a sequence of generating key indicator data, wherein the key indicator data comprises one or more of a DNS resolution time, a connection time, an initial packet time, an initial buffer time, an initial continuous play time, a buffer time after each stucking, and a continuous play time after each stucking.

12. The method according to claim 1, wherein after the receiving, by the monitoring server, the indicator data, the method further comprises:
drawing a curve graph of a preparation time before an initial buffer based on the indicator data; or
drawing a curve graph of a sum of a preparation time before an initial buffer and a total buffer time based on the indicator data.

13. A terminal, comprising:
at least one processor; and
a memory connected and communicated with the at least one processor, configured to store instructions executable by the at least one processor, wherein
the instructions are executed by the at least one processor to cause the at least one processor to perform the processing process performed by the terminal player in a method for monitoring quality of streaming media;
wherein the method comprises:
simulating, by a terminal player, playing a streaming media resource in a fixed period;
recording, by the terminal player, indicator data for simulating playing the streaming media resource;
sending, by the terminal player, the indicator data to a monitoring server; and
determining, by the monitoring server, current quality of streaming media based on the indicator data.

14. The terminal according to claim 13, wherein the step of simulating, by a terminal player, playing a streaming media resource in a fixed period comprises:
sending, by the monitoring server, task information to the terminal player, wherein the task information comprises a network address, a play duration, a buffer size, and a play period of the streaming media resource; and
simulating, by the terminal player, playing the streaming media resource in the fixed period after receiving the task information.

15. The terminal according to claim 14, wherein the step of simulating, by a terminal player, playing a streaming media resource in a fixed period comprises:
sending, by the terminal player according to the play period, request information of obtaining the streaming media resource, wherein the request information comprises the network address of the streaming media resource;
buffering, by the terminal player after receiving the streaming media resource, the streaming media resource based on the buffer size indicated by the task information, and playing the streaming media resource; and
ending playing when a duration in which the terminal player plays the streaming media resource reaches the play duration indicated by the task information.

16. The terminal according to claim 14, wherein before the step of sending, by the monitoring server, task information to the terminal player, the method comprises:
configuring, by the monitoring server, monitoring information, wherein the monitoring information comprises the task information, an operating system of a terminal player, and a region of the terminal player;
receiving, by the monitoring server, an operating system of the terminal player and a region of the terminal player sent by the terminal player which plays the streaming media resource; and
if the terminal player which plays the streaming media resource has the same operating system and the same region with that of the terminal player in the monitoring information, associate the terminal player which plays the streaming media resource with the task information.

17. The terminal according to claim 16, wherein after the step of associating the terminal player which plays the streaming media resource with the task information, the method comprises:
sending, by the terminal player, task request information to the monitoring server; and
sending, by the monitoring server, task information associated with the terminal player to the terminal player after receiving the task request information.

18. The terminal according to claim 13, wherein the terminal player further sends an Internet Protocol (IP) address of a streaming media server and an IP address of a domain name system (DNS) server while sending the indicator data to the monitoring server.

19. The terminal according to claim 13, wherein the step of determining, by the monitoring server, current quality of streaming media based on the indicator data comprises:
computing, by the monitoring server, a first reference value based on the indicator data, wherein the first reference value is equal to a ratio of a quantity of playing the streaming media resource by the terminal player successfully in a preset period and a total quantity of playing the streaming media resource by the terminal player in the preset period; and
determining that the current quality of streaming media does not meet a requirement if the first reference value is less than a first preset value.

20. A computer readable storage medium that stores computer programs, wherein when executed by a processor, the computer programs implement a processing process performed by the terminal player in a method for monitoring quality of streaming media;
wherein the method comprises:
simulating, by a terminal player, playing a streaming media resource in a fixed period;
recording, by the terminal player, indicator data for simulating playing the streaming media resource;
sending, by the terminal player, the indicator data to a monitoring server; and
determining, by the monitoring server, current quality of streaming media based on the indicator data.
